(19) United States
(12) Patent Application Publication
(10) Pub. No.: US 2007/0102666 A1
(43) Pub. Date: May 10, 2007

(54) Illuminated weight scale control

(76) Inventor: Martin A. Cohen, Ridgefield, CT (US)

Correspondence Address: STEVEN A. GARNER, ESQ.;CONAIR CORPORATION, ONE CUMMINGS POINT ROAD, STAMFORD, CT, 06902, US

(21) Appl. No.: 11/585,067

(22) Filed: Oct. 23, 2006

Related U.S. Application Data
(60) Provisional application No. 60/729,585, filed on Oct. 24, 2005.

(51) Int. Cl. C09K 19/52

(52) U.S. Cl. 252/299.01

(57) ABSTRACT

The face of a weight scale (10) has an outer periphery (12), a central display area (14) with a first display area (16) and a second display area (18). A plurality of peripheral areas (20a-20m) are provided around the central display area (14), and are adapted to automatically and sequentially display various weight-related data.

### CROSS-REFERENCE TO RELATED APPLICATIONS

This patent application claims priority from U.S. Provisional Patent Application 60/729,585 filed on 24 Oct. 2005.

### BACKGROUND OF THE INVENTION

1. Field of the Invention

The present invention relates to weight scales and, more particularly, to weight scales having illuminated control input and output components for controlling and displaying a variety of functions.

2. Description of Related Art

Various known weight scales have a variety of displays that are either digital or analog, and they sometimes have various input buttons. Most are limited to one or two functions and, in order to display different types of data, require a user to memorize a sequence of control steps to achieve the desired output and require a user to bend down and manually depress buttons.

### OBJECTS OF THE PRESENT INVENTION

It is an object of the present invention to provide a weight scale having a multiple display capability and an intuitive and convenient input process to achieve various data in a simple, efficient manner.

These and other objects are achieved by the present invention.

### BRIEF SUMMARY OF THE PRESENT INVENTION

According to the present invention, a weight scale has a central display area with the capability of displaying at least two symbols simultaneously, with the ability of either or both of the symbols changing automatically or in response to input, and a plurality of peripheral displays that are adapted to signal when actively corresponding to one of the symbol displays, preferably by lighting.

### BRIEF DESCRIPTION OF THE DRAWINGS

FIG. 1 is a schematic view of a device according to a first embodiment of the present invention.

FIG. 2 is a schematic view of a device according to a first embodiment of the present invention.

### DETAILED DESCRIPTION OF THE PREFERRED EMBODIMENTS OF THE INVENTION

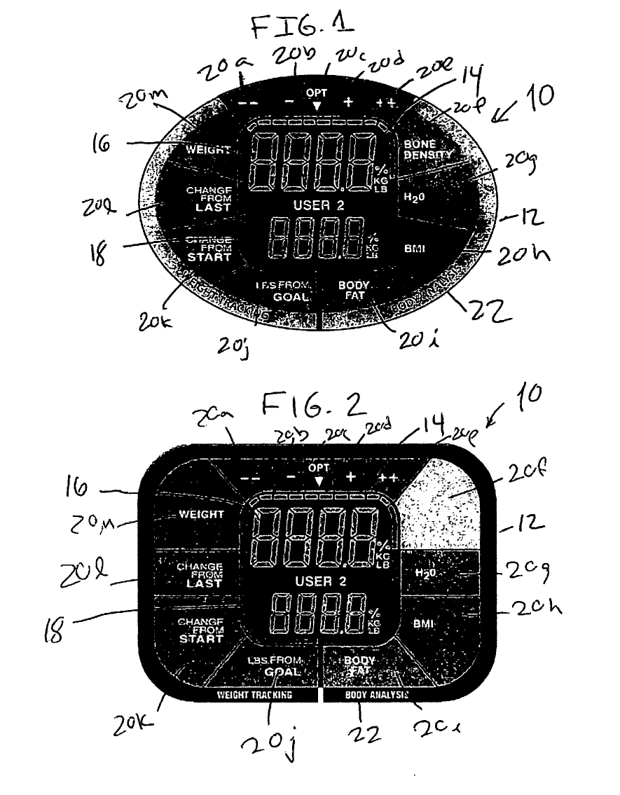

The preferred embodiments of FIGS. 1-2 are essentially similar except for the outer shape-one being an oval (FIG. 1) and the other being a rectangle (FIG. 2). Thus, like numerals will be used in each of FIG. 1 and FIG. 2, and a single text description is provided as follows. It is understood that the present invention is not limited to the specific shapes of the devices shown in these embodiments.

The face of a weight scale (10) has an outer periphery (12), a central display area (14) with a first display area (16) and a second display area (18). A plurality of peripheral areas (20a-20m) are provided around the central display area (14).

The display areas (16, 18) are adapted to display LED, LCD, or other lighted symbols. In the preferred embodiment they display numerals. Each of the peripheral areas (20a-20m) have a function of label such as the word or phrase “weight”; “change from last”; “change from start”; “lbs. from goal”; “body fat”; “BMI” (i.e., body mass index); “H20”; “bone density”; and controls such as: “−−”, “+”, “−”, “++”, and “opt”. The peripheral areas (20a-20m) are adapted to illuminate when a corresponding function or data output is activated.

In operation, a user will tap the scale (10) with his or her foot, thereby initiating an electronically-controlled calibration sequence by means generally known in the trade. The first display area (16), for example, will display “0.0” to indicate calibration is complete. Next, the user will use the “+” and “−” and other buttons to input his or her user number and code corresponding to personal physical data that can be entered earlier in a similar manner. The personal data will be used to calculate such things as body mass index (BMI), body fat, water content, and bone density based on known algorithms that use certain known inputs in combination with weight measurements.

Next, the user steps on the scale and stays on it. The peripheral area (20m) corresponding to “weight” illuminates and the weight of the user is displayed in the first display area (16). Automatically, the peripheral area (20l) corresponding to “change from last” illuminates and the second display area (18) displays the change in weight between the stored data of the user's previous weight and the present user weight. The automatic activation of this display is time-based and pre-programmed to display based on the activation of the scale and the user remaining on the scale.

Next in the sequence, based on a predetermined timing, the “change from last” area (20l) fades from illumination and the “change from start” area (20k) illuminates. The second display area (18) will then display the difference between the present weight and the initial, pre-stored initial weight of when a user started a weight monitoring program. Next, according to the timed sequence, as the user remains standing on the scale, the “change from start” area (20k) fades and the “lb.s from goal” area (20j) illuminates, while a corresponding number displays in the second display area (18) that signifies the difference between the present weight and a pre-stored, user-defined goal weight.

The sequence continues according to a timed program so long as the user remains standing on the scale. Thus, the previously activated peripheral area (20f-20m) will time out and fade, and the next one will activate by illuminating while the second display (18) simultaneously displays corresponding data. The remaining areas are: body fat area (20i); “BMI” (body mass index) area (20h); “H20” area (20g); and “bone density” area (20f). Each one, respectively, will display calculated body fat percentage and body fat in pounds, body mass index, hydration percentage, and bone density percentage of weight.

Additionally, there can be a “ fitness level” bar, or another bar known by an assigned name such as “body analysis” (22) that can illuminate while the second display area (18) displays a number that is calculated as a function of the other parameters calculated earlier.

It is contemplated that variation can be made without departing from the scope of the present invention. For example, the various display areas that correspond to different data do not necessarily have to be configured to surround the first and second display areas, nor do they have to necessarily completely illuminate. For example, they can be organized in columns or rows and have small lights or indicators that illuminate next to them. Another example could have a changing single display that sequentially changes. The common theme is that the display automatically changes based on a timed sequence and sequentially displays data while the user remains on the scale.

What is claimed is:

1) A display panel for a weight scale used for measuring and displaying weight and other data of a user,
said panel having an outer periphery (12), a central display area (14) with a first display area (16) and a second display area (18); and
a plurality of peripheral areas (20a-20m) provided around the central display area (14) and adapted to automatically and sequentially display various weight-related data related to said user.

2) A display panel according to claim 1, wherein
said peripheral areas are adapted to be individually indicated by selective illumination of a portion of said display panel.

3) A display panel according to claim 1, wherein
said central display area is a liquid crystal display.

4) A display panel according to claim 1, wherein
at least one of said peripheral areas corresponds to one of the following: weight; body mass index, body fat percentage, bone density, or water content level.

5) A display panel according to claim 4, wherein
at least a second one of said peripheral areas corresponds to one of the following: change in weight between current weight and last measured weight; change in weight between current weight and first measured weight; and difference between current weight and target goal weight.

6) A display panel according to claim 1, further comprising
a plurality of input control buttons for inputting data relating to said user.

7) A display panel according to claim 1, wherein
said peripheral areas are adapted to be individually and automatically indicated by selective illumination of a portion of said display panel.
